(19) United States
(12) Patent Application Publication
(10) Pub. No.: US 2009/0172234 A1
(43) Pub. Date: Jul. 2, 2009

(54) APPARATUS AND METHOD FOR IDENTIFYING SYSTEM STYLE

(75) Inventors: Hai-Yi Ji, Shanghai City (CN); Shih-Hao Liu, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/098,643

(22) Filed: Apr. 7, 2008

(30) Foreign Application Priority Data
Dec. 28, 2007 (CN) 200710307361.0
Feb. 14, 2008 (TW) 97105186

(51) Int. Cl. G06F 13/00

(52) U.S. Cl. 710/300

(57) ABSTRACT

An apparatus and a method for identifying a system style are provided. The apparatus includes a motherboard and a peripheral backplane. The motherboard is suitable for assembling other backplanes. The peripheral backplane is coupled to the motherboard not only through a signal-data interface but also through an inter-integrated circuit (I2C) bus or a system management (SM) bus. The method includes following steps. First, an identification information is stored on the peripheral backplane. Next, the motherboard reads the identification information from the peripheral backplane through the I2C bus or the SM bus. The motherboard then identifies the system style according to the identification information and is then configured accordingly. Thereby, the motherboard needs not to be configured manually and can be directly applied in different chassis systems supported by the motherboard.

### CROSS-REFERENCE TO RELATED APPLICATION

This application claims the priority benefits of Taiwan patent application serial no. 97105186, filed on Feb. 14, 2008, and P.R.C. patent application serial no. 200710307361.0, filed on Dec. 28, 2007. The entirety of each of the above-mentioned patent applications is hereby incorporated by reference herein and made a part of specification.

### BACKGROUND OF THE INVENTION

1. Field of the Invention

The present invention generally relates to an apparatus and a method, in particular, to an apparatus and a method for identifying a system style.

2. Description of Related Art

There are many different types of servers, and the most common ones are rack-mounted servers and tower servers, wherein the rack-mounted servers include 1 U, 2 U, and 4 U systems, and the tower servers include 5 U and 6 U systems.

When a server manufacturer designs a motherboard, it has to be considered that the motherboard may be applied to the chassis systems of different servers. Since different chassis system has different peripheral configuration, conventionally, a user has to know which type of chassis system the motherboard is applied in so that the user can manually configure the motherboard according to the type of the chassis system.

According to the conventional technique, an identification (ID, usually referred as a system ID) is assigned to a motherboard for identifying different motherboard configuration. For example, a motherboard manufactured by a manufacturer is compatible to 1 U rack-mounted system and 2 U rack-mounted system, and conventionally, a system ID including two bits SYS_ID1 and SYS_ID0 is assigned for identifying different motherboard configurations, wherein the motherboard is applied in a 1 U rack-mounted system when SYS_ID1/0 is 00, and the motherboard is applied in a 2 U rack-mounted system when SYS_ID1/0 is 01. Methods for assigning and updating the system ID include:

1. directly setting the logic level of the system ID through resistance pull-up or pull-down, or updating the system ID by changing the pull-up resistance or the pull-down resistance.

2. storing the system ID in a software, and updating the system ID by updating the software.

3. controlling the pull-up resistance or the pull-down resistance with a switch, and updating the system ID by using the switch.

In all the conventional methods described above, the system ID has to be configured and updated through manual identification and operation and which makes foregoing processes complicated and error-prone. Besides, because the status of the motherboard is changed by manually updating the system ID, the flexibility of using the motherboard in different chassis systems is reduced. Moreover, motherboards manufactured in mass production have to be treated differently regarding different chassis systems.

### SUMMARY OF THE INVENTION

Accordingly, the present invention is directed to an apparatus for identifying a system style, wherein the hardware configuration of a motherboard to a peripheral backplane is realized by that the motherboard reads an identification information through an inter-integrated circuit (I2C) bus or a system management (SM) bus and the motherboard identifies the system style according to the identification information and is then configured accordingly.

The present invention is also directed to a method for identifying a system style, wherein a motherboard needs not to be configured manually and can automatically match itself to a system according to an identification information read from an I2C bus or a SM bus, and accordingly, the motherboard can be directly applied into different chassis systems supported by the motherboard.

The present invention provides an apparatus for identifying a system style, wherein the apparatus is suitable for identifying a system style so as to be configured accordingly. The apparatus includes a motherboard and a peripheral backplane. The motherboard includes a central processing unit (CPU), a signal-data interface, and an I2C bus or a SM bus. The motherboard is suitable for assembling other backplanes. The peripheral backplane is coupled to the motherboard not only through the signal-data interface but also through the I2C bus or the SM bus. An identification information is stored on the peripheral backplane. The hardware configuration of the motherboard to the peripheral backplane is realized by that the motherboard reads the identification information through the I2C bus or the SM bus, and the motherboard identifies the system style according to the identification information and is then configured accordingly.

According to an embodiment of the present invention, the peripheral backplane is a hard disk backplane.

According to an embodiment of the present invention, the peripheral backplane includes a memory for storing the identification information.

According to an embodiment of the present invention, the memory is a read-only memory (ROM).

According to an embodiment of the present invention, the motherboard further includes a chipset and a basic input/output system (BIOS) unit or a baseboard management controller (BMC). The chipset is coupled to the CPU, and the chipset is coupled to the memory through the I2C bus or the SM bus. The BIOS unit or the BMC is coupled to the chipset and reads the identification information through the I2C bus or the SM bus.

According to an embodiment of the present invention, the system style is a rack-mounted style or a tower style.

The present invention provides a method for identifying a system style, wherein the method is suitable for identifying the system style of an apparatus so as to configure the apparatus accordingly. The apparatus includes a motherboard and a peripheral backplane. The motherboard includes a CPU, a signal-data interface, and an I2C bus or a SM bus. The motherboard is suitable for assembling other backplanes. The peripheral backplane is coupled to the motherboard not only through the signal-data interface but also through the I2C bus or the SM bus. The method includes at least following steps. First, an identification information is stored on the peripheral backplane. Then, the motherboard reads the identification information from the peripheral backplane through the I2C bus or the SM bus. Next, the motherboard identifies the system style according to the identification information and is then configured accordingly.

According to an embodiment of the present invention, the step of storing the identification information on the peripheral backplane further includes storing the identification information on a memory of the peripheral backplane.

According to an embodiment of the present invention, the step of reading the identification information through the I2C bus or the SM bus by using the motherboard further includes reading the identification information from the memory by using the motherboard.

In the present invention, an identification information is stored in the peripheral backplane, and the motherboard reads the identification information through an I2C bus or a SM bus. Thereby, the motherboard can automatically match itself to a system according to the identification information read from the peripheral backplane so that the motherboard can be directly applied in different chassis systems supported by the motherboard.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an apparatus according to an embodiment of the present invention.

FIG. 2 is a block diagram of an apparatus according to another embodiment of the present invention.

FIG. 3 is a block diagram of an apparatus according to yet another embodiment of the present invention.

FIG. 4 is a flowchart of a method according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In following description of embodiments of the present invention, when an element is referred as being “connected” or “coupled” to another element, the element may be connected or coupled to the other element directly or through other elements. Contrarily, when an element is referred as being “directly connected” or “directly coupled” to another element, there is no other element in between these two elements.

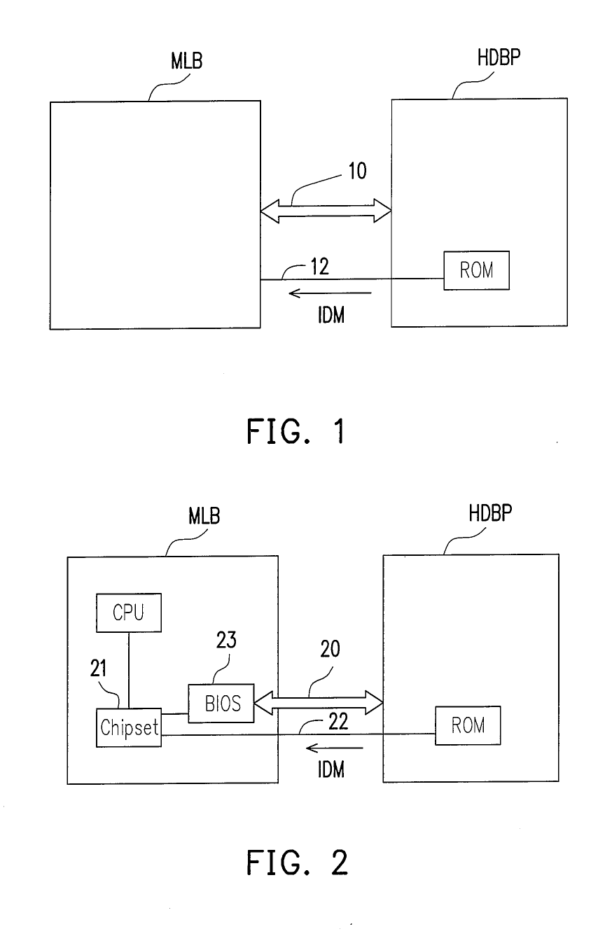

FIG. 1 and FIG. 2 are respectively block diagrams of apparatuses according to embodiments of the present invention. Different chassis systems have different peripheral configurations. Accordingly, a motherboard MLB can automatically identify a system style thereof by identifying a peripheral equipment connected to the system. The motherboard MLB is a circuit board having a central processing unit (CPU, not shown), a signal-data interface 10, and a bus 12, and the motherboard MLB is suitable for assembling the backplanes of other circuits. In the present embodiment, a motherboard MLB compatible to the most popular 1 U rack-mounted or 2 U rack-mounted server system is described as an example. However, it should be understood by those skilled in the art that the system style may be a rack-mounted style or a tower style, and the present embodiment may also be applied to other computer systems without departing the spirit and scope of the present invention.

Referring to FIG. 1, a 1 U rack-mounted system and a 2 U rack-mounted system can accommodate different numbers of hard disks for they have different chassis heights, and accordingly, different peripheral backplanes can be designed correspondingly. In the present embodiment, the peripheral backplane is a hard disk backplane, and the motherboard MLB and the peripheral backplane HDBP are connected through not only through the signal-data interface 10 but also through the bus 12, wherein the bus 12 may be an inter-integrated circuit (I2C) bus or a system management (SM) bus.

Accordingly, information of the 1 U rack-mounted system or the 2 U rack-mounted system can be stored on the peripheral backplane HDBP. For example, a system identification (ID) or a backplane ID which can be used for identifying the peripheral backplane HDBP is stored in a memory ROM of the peripheral backplane HDBP, wherein the memory ROM may be a read-only memory or may also be other types of storage media. The hardware configuration of the motherboard MLB to the peripheral backplane HDBP is realized by that the motherboard MLB reads an identification information IDM from the peripheral backplane HDBP through the I2C bus or the SM bus 12, and the motherboard MLB identifies the system style between itself and the peripheral backplane HDBP according to the identification information IDM and is then configured accordingly.

Referring to FIG. 2, the motherboard MLB includes a chipset 21 coupled to the memory ROM of the peripheral backplane HDBP. The chipset 21 is coupled to the memory ROM through a bus 22, wherein the bus 22 may be an I2C bus or a SM bus.

The motherboard MLB may further includes a CPU and a basic input/output system (BIOS) unit 23. The CPU is coupled to the chipset 21. The BIOS unit 23 is coupled to the chipset 21, and the motherboard MLB is connected to the peripheral backplane HDBP through a signal-data interface 20.

When the system is turned on, the BIOS unit 23 on the motherboard MLB reads the identification information IDM from the peripheral backplane HDBP through the bus 22 connected to the peripheral backplane HDBP. The motherboard MLB identifies the system style according to the identification information IDM and accordingly gets to know that whether the current system in which the motherboard MLB is applied is a rack-mounted system or a tower system, or the motherboard MLB may even get to know that whether the current system is a 1 U rack-mounted system or a 2 U rack-mounted system etc., and is then configured accordingly.

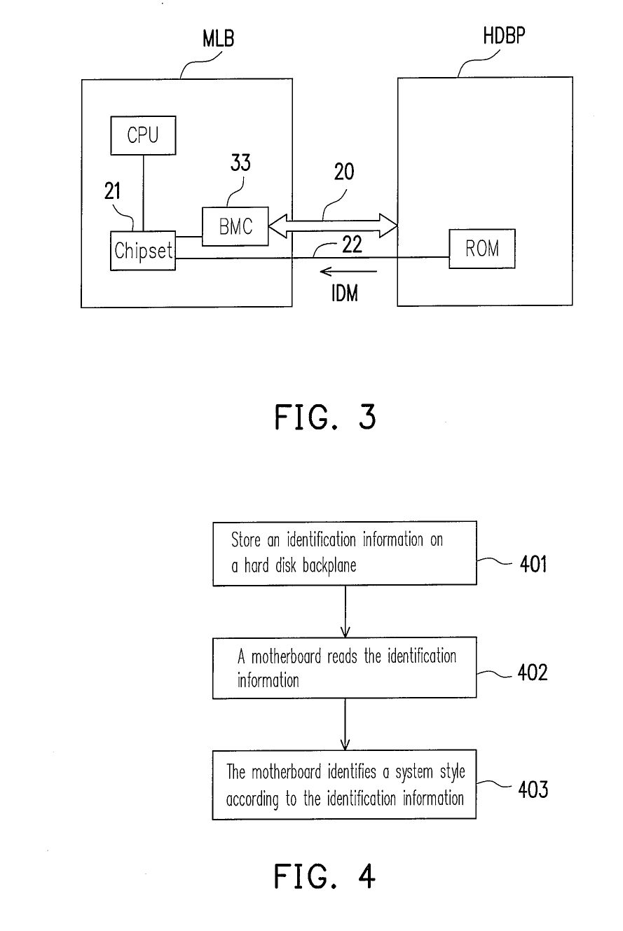

FIG. 3 is a block diagram of an apparatus according to another embodiment of the present invention. Referring to FIG. 3, most elements in FIG. 3 are the same as those in FIG. 2 except a baseboard management controller (BMC) 33. The BMC 33 is used for providing a communication channel for the CPU in the system and may also be used for reading a system detection value and recording the related data. The function of the BMC 33 is the same as that of the BIOS unit 23 illustrated in FIG. 2, and which can read the identification information IDM stored on the peripheral backplane through the I2C bus or the SM bus.

FIG. 4 is a flowchart of a method according to an embodiment of the present invention, wherein the implementation of steps 401˜403 may be referred to the description of foregoing embodiments illustrated in FIG. 1, FIG. 2, and FIG. 3 therefore will not be described herein.

In the embodiments described above, it is not needed to assign different system ID on the motherboard, and when the motherboard is applied in different systems, the hardware equipments can be directly assembled, and the motherboard automatically identifies the information stored on the peripheral backplane when the system is turned on, so as to identify the system style. Since no manual operation is required in foregoing embodiments, misoperation can be avoided and motherboards manufactured in mass production do not need to be treated differently regarding 1 U and 2 U systems.

In overview, different chassis systems have different peripheral configurations. Accordingly, in embodiments of the present invention, a motherboard automatically identifies the system style by identifying a peripheral backplane connected thereto. Thereby, in embodiments of the present invention, the motherboard is not manually configured and can be directly applied in different chassis systems. As a result, the same motherboard can be directly applied into different chassis systems supported by the motherboard, and which makes the application of the motherboard very convenient and flexible.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus suitable for identifying a system style so as to be configured accordingly, the apparatus comprising:
a motherboard, comprising a CPU, a signal-data interface, and an inter-integrated circuit (I2C) bus or a system management (SM) bus, wherein the motherboard is suitable for assembling other backplanes; and
a peripheral backplane, coupled to the motherboard not only through the signal-data interface but also through the I2C bus or the SM bus, wherein an identification information is stored in the peripheral backplane,
wherein the hardware configuration of the motherboard to the peripheral backplane is realized by that the motherboard reads the identification information from the peripheral backplane through the I2C bus or the SM bus, and the motherboard identifies the system style according to the identification information.

2. The apparatus according to claim 1, wherein the peripheral backplane is a hard disk backplane.

3. The apparatus according to claim 1, wherein the peripheral backplane comprises a memory for storing the identification information.

4. The apparatus according to claim 3, wherein the memory is a read-only memory (ROM).

5. The apparatus according to claim 3, wherein the motherboard further comprises:
a chipset, coupled to the CPU, wherein the chipset is coupled to the memory through the I2C bus or the SM bus; and
a BIOS unit, coupled to the chipset, wherein the BIOS unit reads the
identification information through the I2C bus or the SM bus.

6. The apparatus according to claim 3, wherein the motherboard further comprises:
a chipset, coupled to the CPU, wherein the chipset is coupled to the memory through the I2C bus or the SM bus; and
a baseboard management controller (BMC), coupled to the chipset, wherein the BMC reads the identification information through the I2C bus or the SM bus.

7. The apparatus according to claim 1, wherein the system style is a rack-mounted style or a tower style.

8. A method suitable for identifying a system style of an apparatus so as to configure the apparatus accordingly, wherein the apparatus comprises a motherboard and a peripheral backplane, the motherboard comprises a CPU, a signal-data interface, and a I2C bus or a SM bus, the motherboard is suitable for assembling other backplanes, and the peripheral backplane is coupled to the motherboard not only through the signal-data interface but also through the I2C bus or the SM bus, the method comprising:
storing an identification information on the peripheral backplane;
reading the identification information through the I2C bus or the SM bus by using the motherboard; and
identifying the system style according to the identification information by using the motherboard.

9. The method according to claim 8, wherein the step of storing the identification information on the peripheral backplane further comprises storing the identification information on a memory of the peripheral backplane.

10. The method according to claim 9, wherein the step of reading the identification information through the I2C bus or the SM bus by using the motherboard further comprises reading the identification information from the memory by using the motherboard.
